(19) United States
(12) Patent Application Publication
(10) Pub. No.: US 2007/0243495 A1
(43) Pub. Date: Oct. 18, 2007

(54) ELECTRONIC GAS CONTROL SYSTEM

(75) Inventors: Andrew Crnkovich, Elmhurst, IL (US); Konstantin A. Shukhmin, Tauranga (NZ); Rana J. Waitai, Tauranga (NZ); Andrew J. Palmer, Tauranga (NZ)

Correspondence Address: REINHART BOERNER VAN DEUREN P.C., 2215 PERRYGREEN WAY, ROCKFORD, IL, 61107, US

(73) Assignee: ROBERTSHAW CONTROLS COMPANY, Richmond, VA (US)

(21) Appl. No.: 11/736,218

(22) Filed: Apr. 17, 2007

Related U.S. Application Data
(60) Provisional application No. 60/792,775, filed on Apr. 18, 2006.

(51) Int. Cl. F23N 5/00; A01G 13/06

(52) U.S. Cl. 431/18; 431/75

(57) ABSTRACT

An electronic gas control apparatus including a variable flow valve, an igniter, a flame sensor, and an electronic controller is provided. The valve has a flow range that equals or exceeds a required flow range for any one of the types of gas suitably combusted by the burner. The electronic controller is operably coupled to each of the valve, the igniter, and the sensor. The electronic controller is configured to activate the igniter, to receive a flame status signal from the sensor, and to recognize a position of the valve when the flame status signal indicates a flame at the burner. As such, the electronic controller is calibrated for the gas, line-pressure, jet and burner configuration being used.

### CROSS-REFERENCE TO RELATED PATENT APPLICATIONS

This patent application claims the benefit of U.S. Provisional Patent Application No. 60/792,775, filed Apr. 18, 2006, the teachings and disclosure of which are hereby incorporated in their entireties by reference thereto.

### FIELD OF THE INVENTION

This invention generally relates to gaseous fuel burning appliances and, more particularly, to calibration of gas control valves based on a type of gaseous fuel controlled thereby.

### BACKGROUND OF THE INVENTION

When installing a gas operated appliance, a tradesperson is, at times, expected to perform a variety of tasks. For example, the tradesperson may be required to calibrate each valve in the appliance to correspond to the type of gas used by the consumer (e.g., natural gas, liquefied petroleum gas, etc.). In addition, the tradesperson may also have to adjust each valve in the appliance to accommodate line pressure changes from the source supply. Making these adjustments can take considerable time and effort.

In addition to the above, the tradesperson may have to change the jets that have been installed in the appliance at the manufacturer's site. Because the jets are generally made to properly operate with a particular type of gas, the type of jets in the appliance should match the type of gas that the consumer is planning on using. If this is not the case, the tradesperson has the added task of swapping out the jets in the appliance. Making these alterations can take considerable time and effort.

Unfortunately, if a tradesperson has to make field calibrations, adjust for line pressure changes, and replace jets, the cost of the installation and/or servicing of the appliances is greatly increased. There exists, therefore, a need in the art for an apparatus for, and a method of, calibrating a valve, adjusting for pressure changes, and accommodating different jets for the type of gaseous fuel used at an installation location without requiring a tradesperson to physically perform the tedious and time consuming tasks. These and other advantages of the invention, as well as additional inventive features, will be apparent from the description of the invention provided herein.

### BRIEF SUMMARY OF THE INVENTION

The system and method of the present invention allows electronic calibration of the valve for the type of Gas, Line-Pressure, Jet and Burner Configuration (GLPJ&BC) to be used in an appliance (in relation to the valve/metering device only) without the need to have a tradesperson manually adjusting on site.

In one embodiment, an electronic gas control apparatus is provided. The apparatus includes a variable flow valve, an igniter, a flame sensor, and an electronic controller. The variable flow valve has a flow range that equals or exceeds a required flow range for each gas suitably combusted by the burner in the appliance. The igniter is disposed proximate the burner and configured to ignite the gas dispensed by the burner to produce a flame. The flame sensor is disposed proximate the burner and configured to monitor for a presence of the flame. The electronic controller is operably coupled to each of the variable flow valve, the igniter, and the flame sensor, and is configured to control the position of the variable flow valve, to activate the igniter, to receive a flame status signal from the flame sensor, and to vary the position of the variable flow valve until a flame is sensed. The controller then adjusts or calibrates its variable flow valve control algorithm based on the initial position when the flame status signal indicates a flame at the burner. As such, the electronic controller is calibrated for the GLPJ&BC being used.

In another embodiment, a method of calibrating the controller of a variable flow valve is provided. The method includes sending an ignition signal and varying a position of the variable flow valve until receiving an ignition status signal. The method further includes recognizing a valve position if the ignition status signal indicates a flame and sending a valve position signal if the ignition status signal indicates ignition failure.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified schematic of an exemplary embodiment of an electronic gas control apparatus in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

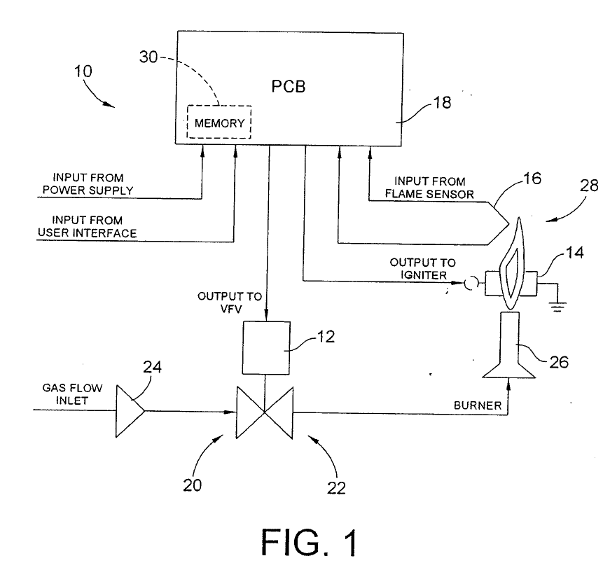

Referring to FIG. 1, an electronic gas control apparatus 10 is illustrated. As will be more fully explained below, the gas control apparatus 10 permits calibration of a valve, adjustment for pressure changes of a source, and accommodation for different jets and burner configuration for the type of gaseous fuel used at an installation location without requiring a tradesperson to physically perform the tedious and time consuming tasks typically required when a gas burning appliance is installed at a consumer location. As shown, the gas control apparatus 10 comprises a variable flow valve (VFV) 12, an igniter 14, a flame sensor 16, and an electronic controller 18.

The variable flow valve 12 defines an inlet 20 and an outlet 22. The inlet 20 is operably coupled to a fuel supply 24 while the outlet 22 is operably coupled to a burner 26. In the illustrated embodiment, the valve 12 is coupled to fuel supply that distributes a gaseous fuel. Therefore, for the purposes of illustration and ease of reading, in the paragraphs below the fuel may be referred to as a gas.

In order to meter out various flow rates of gas or restrict the flow of gas altogether, the valve 12 is able to assume a variety of different positions. In one embodiment, the valve 12 has eighteen metering positions where gas is dispensed from the valve at various rates, although one skilled in the art will recognize from this description that more or fewer metering positions may be used. The valve 12 also has one “off” position where gas is prevented from being metered out.

The variable flow valve 12 in the illustrated embodiment suitably receives and dispenses a variety of different gases (e.g., natural gas, liquefied petroleum gas, propane etc.). In order to provide proper heating and functionality of the appliance regardless of the type of gas used by the consumer, the valve 12 is designed to have a flow range that equals or exceeds the maximum flow range for any one type of gas that may be used in the apparatus 10 and/or combusted by the burner 20.

In one embodiment, the valve 12 is a variable flow valve such as that disclosed in U.S. Pub. Pat. Appln. 2006/0278285 entitled “Variable Flow Valve,” the teachings and disclosure of which are hereby incorporated in their entireties by reference thereto. In another embodiment, the valve 12 is a variable flow valve as disclosed in patent application Ser. No. 11/736,199 entitled “Power Saving Locking Coil” filed on Apr. 17, 2007, the teachings and disclosure of which are hereby incorporated in their entireties by reference thereto.

The valve 12 is operably coupled to and controlled by the controller 18. In the illustrated embodiment of FIG. 1, the valve 12 is shown receiving a signal from the controller 18. The signal is, for example, a valve position signal instructing the valve to close or assume one of the available metering positions to control the amount of gas delivered to the burner 26.

As shown in FIG. 1, the electric igniter 14 is disposed proximate the burner 26. The igniter 14 is configured to ignite the gas dispensed by the burner 26 to produce a flame 28. The igniter 14 is operably coupled to and controlled by the controller 18. In the illustrated embodiment of FIG. 1, the igniter 14 is shown receiving a signal from the controller 18. The signal is, for example, an ignite signal instructing the igniter 14 to attempt to ignite the gas exiting the burner 26.

The flame sensor 16 is disposed proximate the burner 26 and positioned to sense the flame 28. The flame sensor 16 is operably coupled to the controller 18 so that the controller 18 can determine when a flame is present. In the illustrated embodiment of FIG. 1, the flame sensor 16 is shown transmitting a signal to the controller 18. The signal allows the controller 18 to detect that either a flame is present or that a flame is absent at the burner.

As noted above, the electronic controller 18 is operably coupled to each of the valve 12, the igniter 14, and the flame sensor 16. Therefore, the electronic controller 18 is able to control the flow of gaseous fuel from the gas flow supply 24 to the burner 26. Although not shown, the controller 18 may contain numerous typical electronic components and systems such as, for example, a microprocessor or microcontroller, inputs and outputs, transmitting and receiving equipment, peripheral attachment connectors, and the like.

By using the valve 12 in conjunction with the flame sensor 16 and the electronic igniter 14, it becomes possible for the controller 18 to determine at what position inside the multi-position valve 12 when the gas will, and will not, ignite for any particular Gas, Line-Pressure, Jet and Burner Configuration (GLPJ&BC). This electronic sensing when the flame 28 is, or is not, present allows the controller 18 to calibrate itself on start-up for any particular set-up. This activity can be done on installation and/or during a recalibration reset stage if so required.

The electronic controller 18 is also operably coupled to a power supply and a user interface. As shown in FIG. 1, an input from the power supply delivers power to the controller 18. Likewise, an input from the user interface transmits instructions, status requests, and the like to the electronic controller 18. Although the controller 18 is shown receiving a signal from the user interface in the illustrated embodiment, those skilled in the art will recognize that the controller 18 may also transmit signals to the user interface.

Among being able to perform a host of other functions, the electronic controller 18 is configured to activate the igniter 14, to receive a flame status signal from the flame sensor 16, to control the position of the valve 12, and to recognize a position of the variable flow valve 12 when the flame status signal indicates a flame 28 at the burner 26. Therefore, as will be more fully explained below, the controller 18 uses the variable flow valve 12 to calibrate its settings for the particular GLPJ&BC being used at its particular consumer location.

In one embodiment, the electronic controller 18 includes a memory 30. The memory 30 is used by the controller 18 in one embodiment to store, at least temporarily, information regarding the valve 12 and its positions. Information regarding the igniter 14, the flame sensor 16, and the controller 18 itself may also be stored in the memory 30.

The electronic controller 18 may be configured with a logic based software program, program logic, etc. that allows the controller 18 to perform a calibration operation to properly configure the operating parameters of the appliance based on the GLPJ&BC at the consumer location. Specifically, the controller 18 at start up calibration will adjust the valve 12 to allow an amount of gaseous fuel flow to the burner 26. The controller 18 will control the igniter 14 to attempt to ignite the gaseous fluid flowing to the burner 26. Once the flame sensor 16 detects that a flame is present, the controller 18 adjusts its control algorithms to properly control the flow of the gaseous fuel via the valve 12 for the particular installation based on the position of the valve 12 at initial ignition, regardless of the particular Gas, Line-Pressure, Jet and Burner Configuration (GLPJ&BC).

In one embodiment, in operation the controller 18 sends an initial valve position signal to the valve 12. As such, gas from the gas supply 24 is released through the valve 12 to the burner 26. Thereafter, the controller 18 sends an ignition signal to the igniter 14. The flame sensor 16 then operates to confirm the presence or absence of the flame 28 at the burner 26. After monitoring for the flame 28, the flame sensor 16 sends an ignition status signal that is received by the controller 18.

If the flame status signal indicates that the flame 28 is present, the controller 18 utilizes this valve position as the initial or minimum setting for controlling the burner flame. If desired, the valve position and a flame status indicator is stored in memory, transmitted to the user interface or elsewhere, displayed on the user interface or elsewhere, or otherwise utilized. The controller 18 can also inform a user through, for example, the user interface if the flame is present or not.

If the flame status signal indicates that the flame 28 is absent, i.e. there has been an ignition failure, the controller 18 adjusts the valve position signal to the valve 12 to increase the flow of gas therethrough. This is continued until a flame is detected. Once detected, the controller 18 uses this valve position as the minimum setting for control of the appliance.

Each of the above steps may be performed during an initial installation or during a recalibration process. Also, if pressure changes occur in the fuel supply 24, using the above method the controller 18 is able to adjust the position of the valve 12 accordingly. Initiation of such a recalibration process may be effectuated via the user interface.

From the foregoing, those skilled in the art will recognize that the apparatus 10 and method of using the same permits field calibration and proper usage of an appliance at an installation location regardless of the GLPJ&BC, without requiring a tradesperson to physically perform the tedious and time consuming tasks. Thus, the apparatus 10 and the use thereof saves time and money.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An electronic gas control apparatus for use in an appliance, comprising:
a burner;
a variable flow valve operatively coupled to the burner to control a supply of gas thereto, the valve having a flow range that at least equals a maximum flow range for any one type of gas that may be used by the appliance;
an igniter disposed proximate the burner, the igniter configured to ignite the gas dispensed by the burner to produce a flame;
a flame sensor disposed proximate the burner, the flame sensor configured to monitor for presence of the flame; and
an electronic controller operatively coupled to each of the variable flow valve, the igniter, and the flame sensor; and
wherein the electronic controller is configured to self calibrate for at least one of gas, line-pressure, jet and burner configuration by controlling the valve to vary a flow rate of gas therethrough while activating the igniter and monitoring the flame sensor, the controller setting an initial position for valve operation upon detection of flame at the burner.

2. The apparatus of claim 1, wherein the variable flow valve has an inlet and an outlet, the inlet coupled to a gas supply and the outlet coupled to the burner.

3. The apparatus of claim 1, wherein the controller is operatively coupled to a user interface, and wherein the controller is configured to self calibrate upon receipt of a user input requesting same.

4. The apparatus of claim 1, wherein the gases suitably combusted by the burner are natural gas, propane and liquefied petroleum gas.

5. The apparatus of claim 1, wherein the controller varies the flow rate of gas in discrete steps.

6. The apparatus of claim 1, wherein the controller utilizes the initial position as a minimum operating position of the valve during operation of the appliance.

7. The apparatus of claim 1, wherein the controller utilizes the initial position as a low flame setting of the valve during operation of the appliance.

8. A method of calibrating a gas burning appliance for at least one of gas, line-pressure, jet and burner configuration, comprising the steps of:
starting a flow of gas at a first flow rate;
attempting to ignite the gas;
monitoring for ignition of the gas; and
when the gas fails to ignite at the first flow rate, increasing the flow rate of the gas and repeating the steps of attempting to ignite and monitoring for ignition; and
when the step of monitoring indicates that ignition of the gas has occurred, setting the flow rate at ignition as a minimum flow rate for operation of the appliance.

9. The method of claim 8, wherein the step of increasing the flow rate comprises the step of increasing the flow rate by discrete amounts.

10. The method of claim 8, further comprising the step of installing the appliance at a consumer location, and wherein the steps of starting, attempting, monitoring, increasing and setting are performed upon completion of the step of installing.

11. The method of claim 8, further comprising the step of receiving a user initiated recalibration signal, and wherein the steps of starting, attempting, monitoring, increasing and setting are performed upon receipt of the recalibration signal.

12. The method of claim 8, wherein the step of starting a flow of gas comprises the step of energizing a variable flow gas valve to open to a first position.

13. The method of claim 12, wherein the step of increasing the flow rate comprises the step of energizing the variable flow gas valve to open to a second position allowing more gas to flow through the variable flow gas valve.

14. The method of claim 13, wherein the step of increasing the flow rate comprises the step of successively energizing the variable flow gas valve to open to successive positions, each allowing more gas to flow through the variable flow gas valve than a previous position.

15. A method of calibrating a controller for a gas burning appliance for gas type, line-pressure, jet and burner configuration, the appliance having a burner, an igniter, a flame sensor, and a variable flow gas control valve operative to control a flow of gas to the burner, comprising the steps of:
commanding the valve to open to allow a first rate of gas to flow therethrough;
energizing the igniter;
monitoring the flame sensor for an indication of flame;
commanding the valve to open further to allow a second rate of gas to flow therethrough, the second rate being greater than the first rate, when the step of monitoring does not indicate that a flame is present at the first rate;
repeating the step of commanding the valve to open further until the step of monitoring indicates that the flame is present; and
setting a minimum operating position of the valve to a position corresponding to the position when the step of monitoring indicates that the flame is present.

16. The method of claim 15, wherein the step of commanding the valve to open further comprises the step of commanding the valve to open further by a discrete amount.

17. The method of claim 15, further comprising the step of installing the appliance at a consumer location, and wherein the steps of commanding, energizing, monitoring, commanding, repeating, and setting are performed upon completion of the step of installing.

18. The method of claim 15, further comprising the step of receiving a user initiated recalibration signal, and wherein the steps of commanding, energizing, monitoring, commanding, repeating, and setting are performed upon receipt of the recalibration signal.

19. The method of claim 15, further comprising the steps of receiving a user command to turn on a burner, commanding the valve to open to the minimum operating position, and energizing the igniter.

20. The method of claim 19, further comprising the steps of monitoring the flame sensor for an indication of flame, and repeating the steps of claim 15 when the step of monitoring indicates that no flame is present.
